(19) United States
(12) Patent Application Publication
(10) Pub. No.: US 2022/0215459 A1
(43) Pub. Date: Jul. 7, 2022

(54) Tow Service Location System

(71) Applicants: Derek Rezendes, Tucker, GA (US); Frank Robinson, JR., Tucker, GA (US); Roderick Breland, Tucker, GA (US)

(72) Inventors: Derek Rezendes, Tucker, GA (US); Frank Robinson, JR., Tucker, GA (US); Roderick Breland, Tucker, GA (US)

(21) Appl. No.: 17/143,257

(22) Filed: Jan. 7, 2021

(51) Int. Cl. G06Q 30/06; G01S 19/14

(52) U.S. Cl. CPC G06Q 30/0639; G01S 19/14; G06Q 30/0629

(57) ABSTRACT

A tow service location system for hiring a tow service for a stranded vehicle includes the internet and a global positioning system (gps). Operational software comprising a tow service location app is installed and operational on a smart device. The location app includes a dispatch algorithm that is in communication with the user and potential towing operators via the internet and the gps. Moreover, the dispatch algorithm is in communication with a plurality of tow services each being located within a pre-determined distance from the smart device. The smart device is in communication with the gps to establish the physical location of the user. The web-enabled tow service location app identifies all of the available tow services within the agreed-upon pre-determined radius of the user and the costs associated with the selection of the service.

### CROSS-REFERENCE TO RELATED APPLICATIONS

### Not Applicable

### STATEMENT REGARDING FEDERALLY SPONSORED RESEARCH OR DEVELOPMENT

### Not Applicable

### THE NAMES OF THE PARTIES TO A JOINT RESEARCH AGREEMENT

### Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

### Not Applicable

### STATEMENT REGARDING PRIOR DISCLOSURES BY THE INVENTOR OR JOINT INVENTOR

### Not Applicable

### (g) BACKGROUND OF THE INVENTION

### (1) Field of the Invention

The disclosure relates to tow service devices and more particularly pertains to a new tow service device for hiring a tow service for a stranded vehicle.

### (2) Description of Related Art Including Information Disclosed Under 37 CFR 1.97 and 1.98

The prior art relates to tow service devices including a method of managing a service request that includes a smart phone to send gps information over the internet for roadside assistance. The prior art discloses a roadside assistance system that includes an electronic internet and at least one smart device for requesting roadside assistance. The prior art discloses an assistance request system that includes a subsystem for receiving an assistance request, a subsystem to identify the location of the requester and a subsystem for identifying the members of an assistance network that are within a pre-determined distance from the requester. Additionally, the prior art discloses a roadside assistance system that includes a collection module, an assignment module and a feedback module for requesting roadside assistance.

### BRIEF SUMMARY OF THE INVENTION

An embodiment of the disclosure meets the needs presented above by generally comprising the internet/global positioning system (gps). Operational software comprising a tow service location app is installed and operational on a smart device. The location app includes a dispatch algorithm that is in communication with the user and potential towing operators via the internet/gps. Moreover, the dispatch algorithm is in communication with a plurality of tow services each being located within a pre-determined distance from the smart device. The smart device is in communication with the gps to establish the physical location of the user. The web-enabled tow service location app identifies all of the available tow services within the agreed-upon pre-determined radius of the user and the costs associated with the selection of the service.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a smart device of a tow service location system according to an embodiment of the disclosure.

FIG. 2 is an in-use view of an embodiment of the disclosure.

FIG. 3 is a logic tree view of an embodiment of the disclosure.

### DETAILED DESCRIPTION OF THE INVENTION

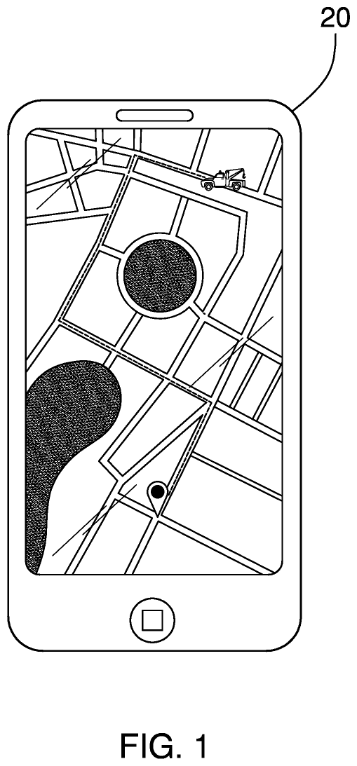

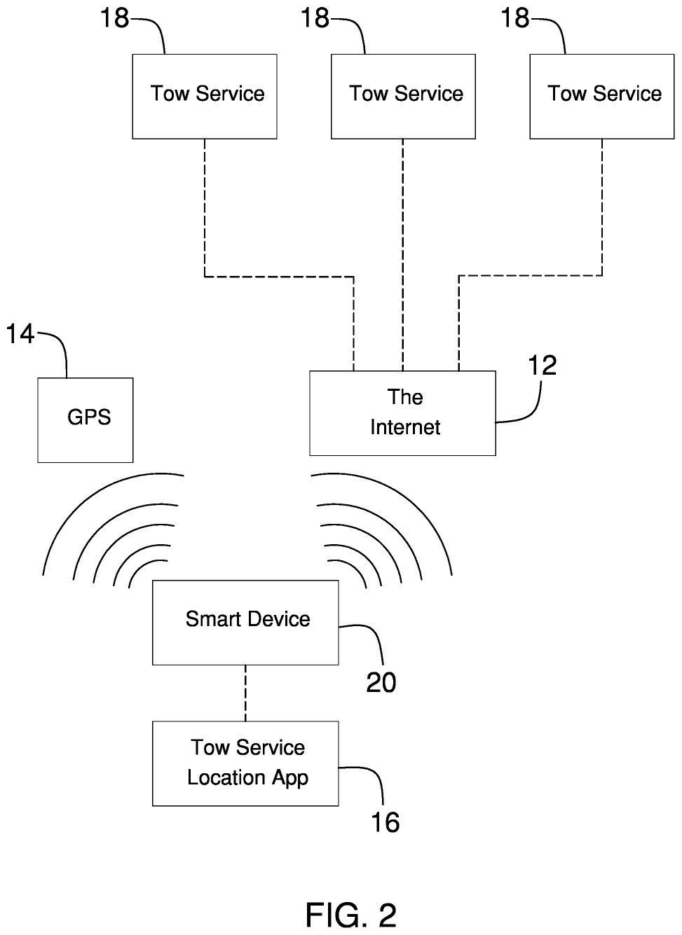

With reference now to the drawings, and in particular to FIGS. 1 through 3 thereof, a new tow service device embodying the principles and concepts of an embodiment of the disclosure and generally designated by the reference numeral 10 will be described.

As best illustrated in FIGS. 1 through 3, the tow service location system 10 generally comprises the internet 12, which may be accessed via a wireless router or an Ethernet router. A global positioning system (gps) 14 is included. A tow service location app 16 is installed on a smart device 20. The tow service location app 16 is a web based application that is in communication with a web based service employed by tow truck services. The smart device 20 may comprise a smart phone, an electronic tablet or other similar device that has wireless communication capabilities, an electronic memory for storing the operational software and an electronic display.

The smart device 20 is in communication with the gps 14 to establish the physical location of the smart device 20 and the smart device 20 is in communication with the internet 12. The tow service location app 16 includes a dispatch algorithm that is in communication with the internet 12 and the gps 14. The dispatch algorithm is in communication with a plurality of tow services 18 that is each located within a pre-determined distance from the smart device 20. Moreover, the dispatch algorithm gathers pricing data and tow equipment availability data from each of the tow services 18.

The tow service location app 16 is manipulated to actuate the dispatch algorithm for identifying all of the tow services 18 within a pre-determined agreed-upon radius of the user and specifically the type of towing required for user's vehicle. Moreover, the smart device 20 receives the pricing data and the tow equipment availability data from the dispatch algorithm. In this way the smart device 20 can display the pricing data and the tow equipment availability data to facilitate the user to choose one of the tow services 18 for hiring. The dispatch algorithm communicates gps location data of the appropriate tow service to the smart device 20. In this way the tow service location app receives gps location data of the appropriate tow service. Thus, the smart device 20 can display the location of the appropriate tow service with respect to the user.

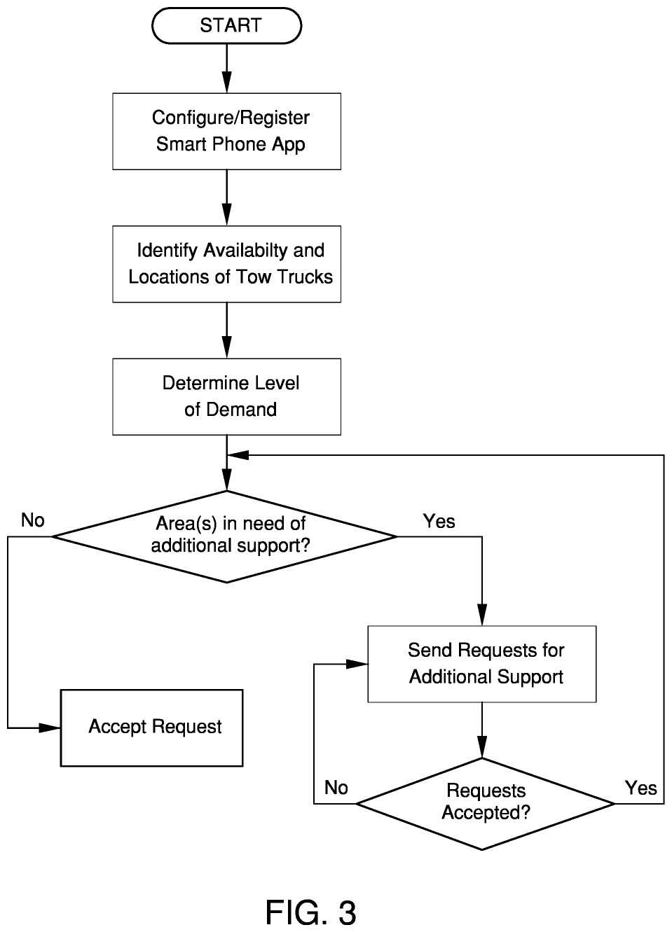

In use, the user manipulates the tow service location app 16 when the user needs to tow their vehicle for any reason. The tow service location app 16 receives the pricing data and the tow equipment availability data for the user to view on the smart device 20. The user chooses a tow service to hire and the dispatch algorithm relays the hire request to the appropriate tow service based on the user's search criteria. Additionally, the dispatch algorithm relays the gps location of the tow service to the smart device 20 so the user can watch the tow service travel to the user's location. As is most clearly shown in FIG. 3, the dispatch algorithm requests additional support from neighboring tow services if no tow services within the pre-determined radius of the user are available for hire.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. (canceled)

2. (canceled)

3. (canceled)

4. (canceled)

5. (canceled)

6. A tow service location system for facilitating a user of a vehicle to locate tow service within a pre-determined radius, said system comprising:
a global positioning system (gps);
an electronic device being configured to be manipulated by a user of a vehicle and configured for communication with a network of computers, said electronic device storing operational software comprising a tow service location app, said electronic device being in communication with said gps to establish a physical location of said electronic device, said tow service location app being manipulated to actuate a dispatch algorithm to identify all of the tow services within a pre-determined radius of said electronic device, said electronic device receiving pricing data and tow equipment availability data from said dispatch algorithm thereby facilitating said electronic device to display said pricing data and said tow equipment availability data wherein said electronic device is configured to facilitate the user to choose one of the tow services for hiring, said dispatch algorithm communicating gps location data of an appropriate tow service to said electronic device thereby facilitating said tow service location app to receive gps location data of the appropriate tow service wherein said electronic device is configured to display the location of the appropriate tow service with respect to the user.
